(19) United States
(12) Patent Application Publication
(10) Pub. No.: US 2025/0077668 A1
(43) Pub. Date: Mar. 6, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: TAKAHIRO UEHARA, Kanagawa (JP); KEI TAMAGAWA, Tokyo (JP)

(21) Appl. No.: 18/818,397

(22) Filed: Aug. 28, 2024

(30) Foreign Application Priority Data
Sep. 1, 2023 (JP) 2023-142033

(51) Int. Cl. G06F 21/56

(52) U.S. Cl. CPC G06F 21/564; G06F 21/565; G06F 2221/034

(57) ABSTRACT

An information processing apparatus includes at least one processor and at least one memory, cooperating to receive a file, store the received file, perform virus detection processing on the file, determine whether the file is a normal file in a case where it is determined that the file is suspected of being infected with a virus or that the file is guaranteed as the normal file although an error occurs in the virus detection processing, as a result of the virus detection processing.

### BACKGROUND

### Field

The present disclosure relates to an information processing apparatus, an information processing method, and a storage medium, and especially relates to a method of controlling processing based on virus detection processing.

### Description of the Related Art

A method of using an information processing apparatus to store an image captured by a user with an imaging apparatus or an image provided by an external service has been widely used. The user transmits an image stored in the imaging apparatus or an image stored in the external service to the information processing apparatus via a network, and the image processing apparatus stores the received image. The user is able to perform an operation such as browsing of the image stored in the information processing apparatus and transfer of the image to another user or a service via the user's terminal.

With an aim to ensure security, a method of performing virus detection processing on an image uploaded to an information processing apparatus has been widely used. This allows the user to confirm that the image is not infected with a virus and then utilize the image.

There is a case where virus detection processing is performed also in the user's imaging apparatus or the external service.

In this case, the virus detection processing is performed also when the image is uploaded to the information processing apparatus, resulting in overlapping execution of the virus detection processing. For this reason, even in an image whose security has been ensured by the imaging apparatus or the external service, in a case where a virus is detected by the information processing apparatus or determination cannot be made properly due to an error in the detection processing, there is a case where the image is isolated and unavailable to the user.

The image in which a virus is detected includes an image in which a virus is erroneously detected. It is assumed that the detection of a virus from the image whose security has been ensured as described above is erroneous detection in many cases. However, because it is impossible for the information processing apparatus to confirm whether detection is erroneous detection, the image is unavailable to the user, leading to opportunity loss.

With an aim to avoid overlapping execution of the virus detection processing, Japanese Patent Application Laid-Open No. 2023-38685 discusses a technique of not executing the virus detection processing in an image forming apparatus in a subsequent stage in a case where the virus detection processing has been executed in a print server.

However, there is an issue that, in a case where the information processing apparatus cannot control execution of the virus detection processing, there is no choice but to execute the processing in an overlapping manner. Examples of the case where the information processing apparatus cannot control execution of the virus detection processing include a case where a cloud service or software provided by an external vendor is utilized in the virus detection processing, a built-in application or the like is utilized in an operating system (OS), and the information processing apparatus cannot control timing of execution. For example, there is a case where the virus detection processing is automatically started at timing at which the image is stored in the information processing apparatus.

### SUMMARY

The present disclosure is directed to a technique of not decreasing convenience for a user who utilizes a file even in a case where execution of virus detection processing cannot be controlled.

According to an aspect of the present disclosure, an information processing apparatus includes at least one processor and at least one memory, cooperating to receive a file, store the received file, perform virus detection processing on the file, and determine whether the file is a normal file in a case where it is determined that the file is suspected of being infected with a virus or that the file is guaranteed as the normal file although an error occurs in the virus detection processing, as a result of the virus detection processing.

Further features of the present disclosure will become apparent from the following description of exemplary embodiments with reference to the attached drawings.

### BRIEF DESCRIPTION OF THE DRAWINGS

FIG. 1 is a block diagram illustrating an example of an overall configuration.

FIG. 2 is a block diagram illustrating an example of a hardware configuration of an information processing apparatus.

FIG. 3 is a block diagram illustrating an example of a functional configuration of the information processing apparatus.

FIG. 4 is a flowchart describing processing executed by the information processing apparatus from reception of an image until transmission of the image to a user terminal.

FIG. 5 is a flowchart describing an example of normality guarantee determination processing.

FIG. 6 is a diagram illustrating an example of metadata of an image.

FIG. 7 is a block diagram illustrating an example of a functional configuration of the information processing apparatus.

FIG. 8 is a diagram illustrating an example of transmission source information.

FIG. 9 is a flowchart describing an example of normality guarantee determination processing.

FIG. 10 is a flowchart describing an example of normality guarantee determination processing.

### DESCRIPTION OF THE EMBODIMENTS

The present disclosure will be described in detail below based on exemplary embodiments of the present disclosure with reference to the accompanying drawings. Configurations described in the following exemplary embodiments are merely examples, and the present disclosure is not limited to the configurations illustrated in the drawings.

### <Overall Configuration>

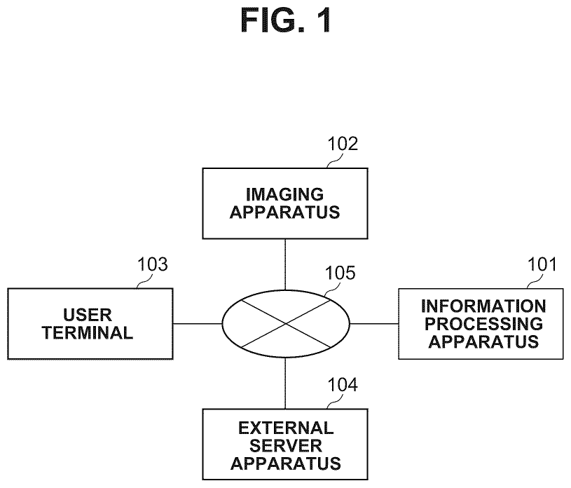

An example of an overall configuration according to a first exemplary embodiment will be described with reference to a block diagram illustrated in FIG. 1. FIG. 1 illustrates an information processing apparatus 101, an imaging apparatus 102, a user terminal 103, an external server apparatus 104, and a network 105 that implements communication among these apparatuses. A plurality of imaging apparatuses 102, a plurality of user terminals 103, and a plurality of external server apparatuses 104 may be provided.

The information processing apparatus 101 receives an image transmitted from the imaging apparatus 102, the user terminal 103, or the external server apparatus 104, and stores the image.

The imaging apparatus 102 is an information processing apparatus owned by a user and having an imaging function and a communication function, and is, for example, a camera.

The user terminal 103 is an information processing apparatus owned by the user and having a communication function, and is, for example, a mobile phone, a smartphone, a personal computer (PC), or a tablet.

The external server apparatus 104 is an external server apparatus that coordinates with the information processing apparatus 101 and that provides a service.

The network 105 may be connected as an identical network such as a local area network (LAN), may be connected as an external network such as the Internet, or may be connected in a mixed manner.

A description will be given mainly of an example regarding an image. However, not only the image, but also a file of any kinds may be used. Assume that the image (file) that has been confirmed as not being infected with a virus is a normal image (normal file).

### <Hardware Configuration>

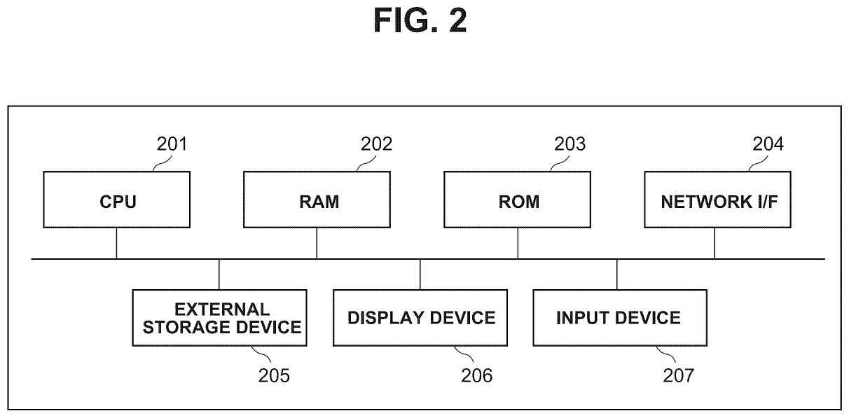

An example of a hardware configuration of the information processing apparatus 101 according to the present exemplary embodiment will be described with reference to a block diagram illustrated in FIG. 2.

The information processing apparatus 101 includes at least a central processing unit (CPU) 201, a random-access memory (RAM) 202, a read-only memory (ROM) 203, a network interface 204, an external storage apparatus 205, a display device 206, and an input device 207.

The CPU 201 controls an operation of each unit included in the information processing apparatus 101, and also serves as a main unit that executes various kinds of processing that will be described below as being executed by the information processing apparatus 101.

The RAM 202 is a memory that temporarily stores data and control information, and serves as a work area that is used by the CPU 201 when the CPU 201 executes various kinds of processing.

Fixed operation setting values of the information processing apparatus 101, an operation program, and the like are stored in the ROM 203.

The network interface 204 provides a function for communication by being connected with the network 105. The information processing apparatus 101 is capable of transmitting/receiving data to/from an external apparatus via the network interface 204.

The external storage apparatus 205 is an apparatus that stores data, and includes an interface that accepts an input/output (I/O) command for reading/writing data. The external storage apparatus 205 may be a hard disk drive (HDD), a solid-state drive (SSD), an optical disk drive, a semiconductor storage apparatus, or another storage device. A computer program and data for causing the CPU 201 to execute each processing, which will be described below as being executed by the information processing apparatus 101, are stored in the external storage apparatus 205.

The display device 206 is, for example, a liquid crystal display (LCD), and displays necessary information to the user.

The input device 207 is, for example, a keyboard, a mouse, or a touch panel, and accepts necessary input from the user.

### <Functional Configuration>

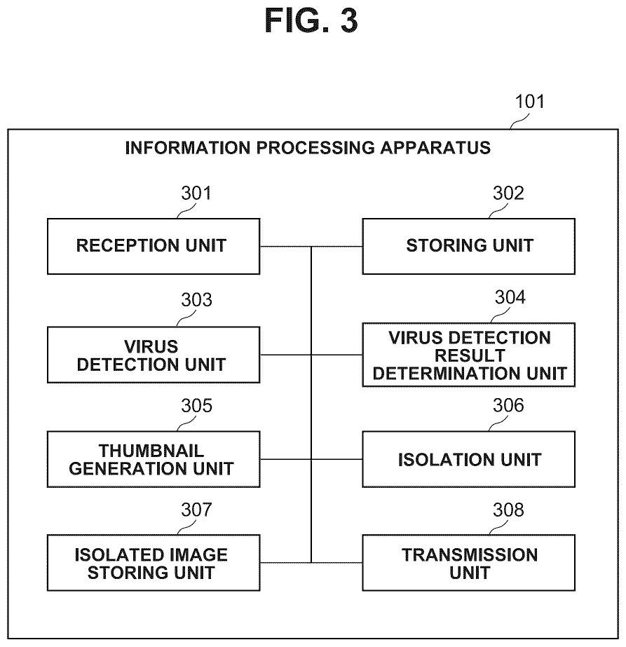

An example of a functional configuration of the information processing apparatus 101 according to the present exemplary embodiment will be described with reference to a block diagram illustrated in FIG. 3.

The information processing apparatus 101 includes a reception unit 301, a storing unit 302, a virus detection unit 303, a virus detection result determination unit 304, a thumbnail generation unit 305, an isolation unit 306, an isolated image storing unit 307, and a transmission unit 308.

The reception unit 301 receives an image and metadata related to the image, which are transmitted from the imaging apparatus 102, the user terminal 103, or the external server apparatus 104. The metadata is a tag or the like transmitted together with the image.

The storing unit 302 stores the image and the metadata related to the image received by the reception unit 301.

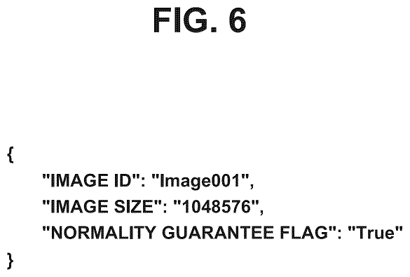

FIG. 6 illustrates an example of metadata stored in the storing unit 302. In the metadata, for example, values corresponding to respective pieces of key information, such as image identification (ID), an image size, and normality guarantee, are described in association with the respective pieces of key information. The image ID is ID for uniquely identifying an image stored in the storing unit 302. The image size indicates a volume of the image with a value in bytes. A normality guarantee flag is information indicating whether the image is guaranteed as a normal image. In a case where the image is guaranteed as the normal image, True is stored. In a case where the image is not guaranteed as the normal image, False is stored. In a case where the virus detection processing has been already performed on the image in the imaging apparatus 102, the user terminal 103, or the external server apparatus 104, and the image has been proved to be the normal image, an image to which the normality guarantee flag indicating True is added is transmitted to the information processing apparatus. Otherwise, an image to which the normality guarantee flag indicating False is added is transmitted to the information processing apparatus 101.

The virus detection unit 303 performs the virus detection processing on the image stored in the storing unit 302. Because the function provided by an external service or software is utilized in the virus detection processing and the virus detection processing is automatically started with the image being stored serving as a trigger, determination about whether to execute the virus detection processing is not under control of the information processing apparatus 101.

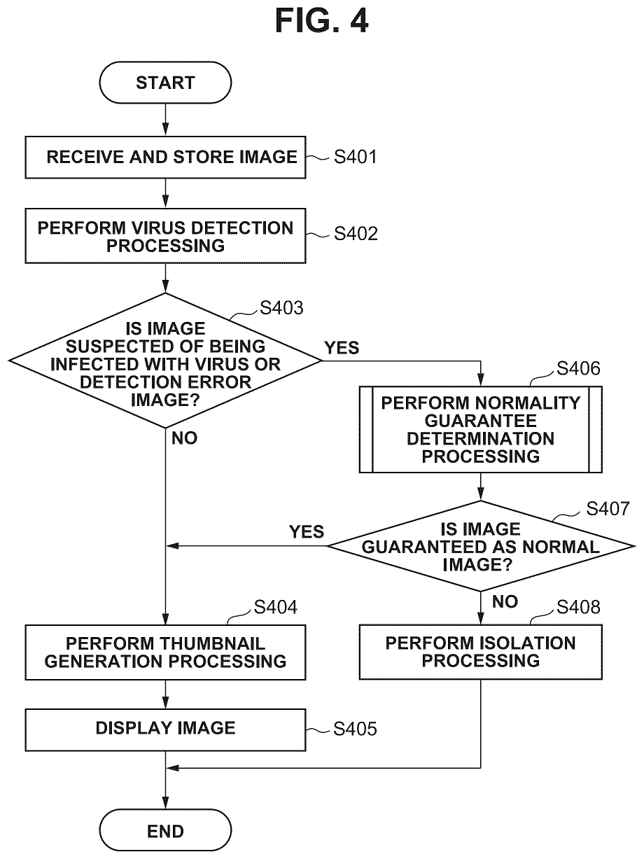

The virus detection result determination unit 304 determines processing on the image based on a virus detection result from the virus detection unit 303 according to the flow in FIG. 4, which will be described below.

The thumbnail generation unit 305 generates a thumbnail image, which is a reduced image of the image.

The isolation unit 306 isolates an image that is suspected of being infected with a virus and metadata related to the image to the isolated image storing unit 307.

The isolated image storing unit 307 stores the image and the metadata related to the image isolated by the isolation unit 306.

In response to a request from a client application on the user terminal 103 or the like, the transmission unit 308 transmits a thumbnail image generated by the thumbnail generation unit 305 or the image stored in the storing unit 302 to the user terminal 103.

### <Flow of Processing>

The flow of a series of processing from the information processing apparatus 101 receiving the image to the information processing apparatus 101 transmitting the image to the user terminal 103 in the present exemplary embodiment will be described with reference to a flowchart of the processing illustrated in FIG. 4. Each process (step) will be described below by attaching S to the head of a reference number thereof.

In step S401, the reception unit 301 receives an image and metadata related to the image, which are transmitted from the imaging apparatus 102, the user terminal 103, the external server apparatus 104, or the like, and stores the image and the metadata in the storing unit 302.

In step S402, with the image being stored serving as a trigger, the virus detection unit 303 performs the virus detection processing on the image stored in the storing unit 302. As a result of the virus detection processing, the image is determined as a normal image, an image that is suspected of being infected with a virus, or a detection error image. The normal image represents an image in which a virus is not detected. The detection error image represents an image in which an error occurs in the virus detection processing by the virus detection unit 303 and determination cannot be made normally.

In step S403, the virus detection result determination unit 304 checks a virus detection result. In a case where the image is the normal image (NO in step S403), the processing proceeds to step S404. In contrast, in a case where the image is suspected of being infected with a virus or is the detection error image (YES in step S403), the processing proceeds to step S406.

In step S404, the thumbnail generation unit 305 generates a thumbnail image of the image.

In step S405, in response to a request from a client application on the user terminal 103 or the like, the transmission unit 308 transmits the thumbnail or the image to the user terminal 103. Displaying the thumbnail or the image received on the client application on a screen allows the user to browse the image.

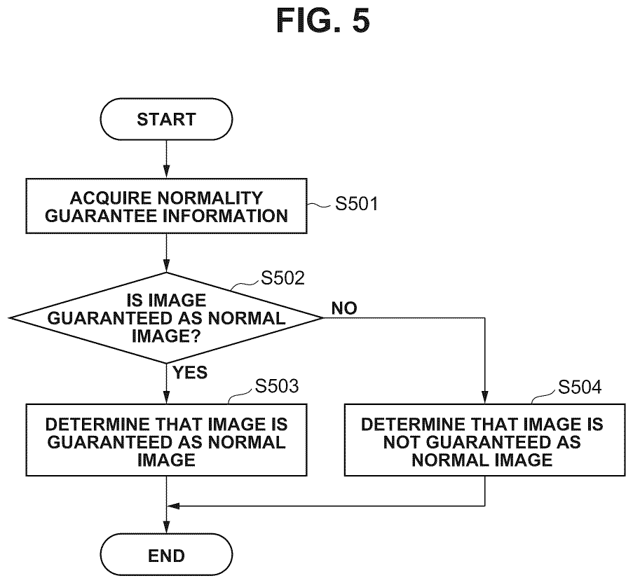

In step S406, the virus detection result determination unit 304 performs normality guarantee determination processing, which will be described below with reference to FIG. 5, to determine whether the image is guaranteed as the normal image.

In step S407, the virus detection result determination unit 304 determines that the image is guaranteed as the normal image in the normality guarantee determination processing in step S406. In a case where the virus detection result determination unit 304 determines that the image is guaranteed as the normal image (YES in step S407), the processing proceeds to step S404. In contrast, in a case where the virus detection result determination unit 304 determines that the image is not guaranteed as the normal image (NO in step S407), the processing proceeds to step S408.

In step S408, the isolation unit 306 isolates the image stored in the storing unit 302 to the isolated image storing unit 307.

The flow of the normality guarantee determination processing is described with reference to FIG. 5 illustrating a flowchart of the processing.

In step S501, the virus detection result determination unit 304 acquires metadata related to an image to be processed from the storing unit 302, and further acquires normality guarantee information from the metadata. Specifically, the virus detection result determination unit 304 acquires a normality guarantee flag, as normality guarantee information, from the metadata.

In step S502, the virus detection result determination unit 304 determines whether the image is guaranteed as the normal image based on the normality guarantee information. Specifically, in a case where a value of the normality guarantee flag is True (YES in step S502), the processing proceeds to step S503. In step S503, the virus detection result determination unit 304 determines that the image is guaranteed as the normal image. In a case where the value of the normality guarantee flag is a value other than True (NO in step S502), the processing proceeds to step S504. In step S504, the virus detection result determination unit 304 determines that the image is not guaranteed as the normal image.

According to the present exemplary embodiment described above, even in a case where the image that is suspected of being infected with a virus is detected or a case where an error occurs in the detection processing, the image is handled as the normal image if the image has been already guaranteed as the normal image, whereby it becomes possible to increase the user's opportunities for utilizing the image.

The above description has been given of the example in which the normality guarantee information is included in the metadata of the image. Besides, a mode in which the normality guarantee information is included in metadata information embedded in the image itself may be employed.

In a second exemplary embodiment, a description will be given of a mode in which normality guarantee determination processing is performed based on transmission source information regarding the image. A component or a step that provides a function that is identical to that in the first exemplary embodiment is denoted by an identical reference sign, and a part that is unchanged from the first exemplary embodiment in terms of a configuration and a function is not described.

### <Functional Configuration>

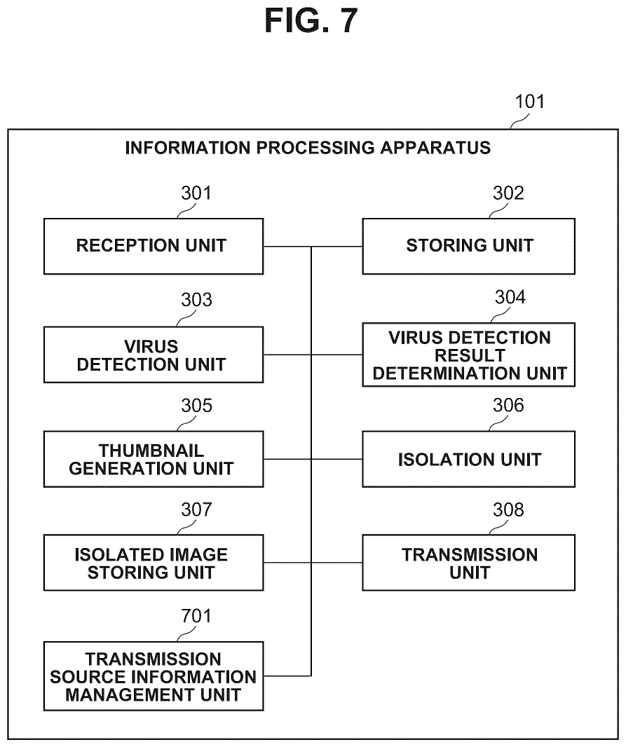

An example of a functional configuration of the information processing apparatus 101 according to the present exemplary embodiment will be described with reference to a block diagram illustrated in FIG. 7.

In comparison with the example of the functional configuration according to the first exemplary embodiment in FIG. 3, a transmission source information management unit 701 is added. The transmission source information management unit 701 manages transmission source information regarding the imaging apparatus 102, the user terminal 103, the external server apparatus 104, or the like, which serves as a transmission source of the image to be transmitted to the information processing apparatus 101.

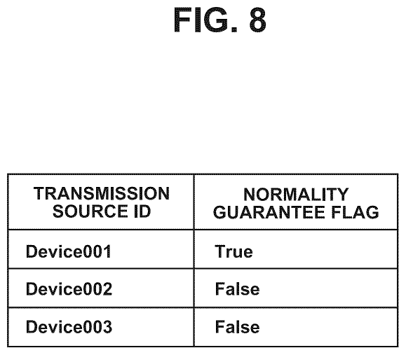

FIG. 8 illustrates an example of transmission source information managed by the transmission source information management unit 701. Transmission source identification (ID) is ID for identifying the transmission source, and the normality guarantee flag is information indicating whether the image transmitted from the transmission source is guaranteed as the normal image. In a case where the normality guarantee flag is True, it indicates that the image is guaranteed as the normal image. In a case where the normality guarantee flag is False, it indicates that the image is not guaranteed as the normal image.

### <Flow of Processing>

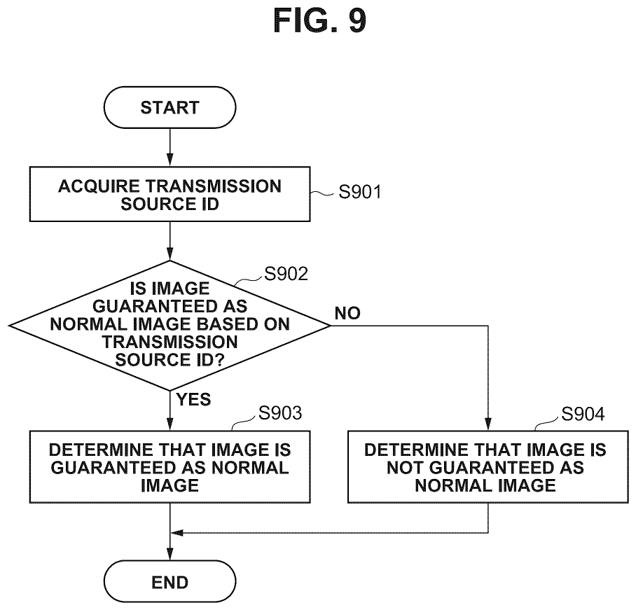

The flow of the normality guarantee determination processing in the present exemplary embodiment is described with reference to FIG. 9 illustrating a flowchart of the processing.

In step S901, the virus detection result determination unit 304 acquires transmission source ID of a processing target image. The transmission source ID is included in additional information and transmitted when the image is transmitted from the imaging apparatus 102, the user terminal 103, or the external server apparatus 104 to the information processing apparatus 101.

In step S902, the virus detection result determination unit 304 determines whether the image is guaranteed as the normal image based on the normality guarantee information. Specifically, the virus detection result determination unit 304 acquires, from the transmission source information management unit 701, a normality guarantee flag of the transmission source ID acquired in step S901. In a case where a value of the normality guarantee flag is True (YES in step S902), the processing proceeds to step S903. In step S903, the virus detection result determination unit 304 determines that the image is guaranteed as the normal image. In a case where the value of the normality guarantee flag is a value other than True (NO in step S902), the processing proceeds to step S904. In step S904, the virus detection result determination unit 304 determines that the image is not guaranteed as the normal image.

According to the present exemplary embodiment described above, it is possible to determine that the image transmitted from a specific transmission source has been guaranteed as the normal image. With this configuration, it is possible to support a case where the determination about whether the image is guaranteed as the normal image is desired to be controlled not on an image-by-image basis, but on a transmission source-by-transmission source basis.

The description has been given of the example of utilizing an identifier of an apparatus or a terminal as the transmission source information. Besides, an identifier of an application or a service that transmits an image on the apparatus or the terminal and an Internet Protocol (IP) address of the transmission source may be utilized.

The transmission source information management unit 701 may manage only transmission source information about a transmission source from which an image guaranteed as the normal image is transmitted. In this case, the virus detection result determination unit 304 determines that an image that is transmitted from a transmission source included in the transmission source information management unit 701 is guaranteed as the normal image, and determines that an image that is transmitted from a transmission source not included in the transmission source information management unit 701 is not guaranteed as the normal image, whereby similar processing can be implemented.

In a third exemplary embodiment, a description will be given of a mode in which normality guarantee determination processing is performed based on storing region information regarding a region in which an image is stored.

A component or a step that provides a function that is identical to that in the other exemplary embodiments is denoted by an identical reference sign, and a part that is unchanged from the other exemplary embodiments in terms of a configuration and a function is not described.

### <Flow of Processing>

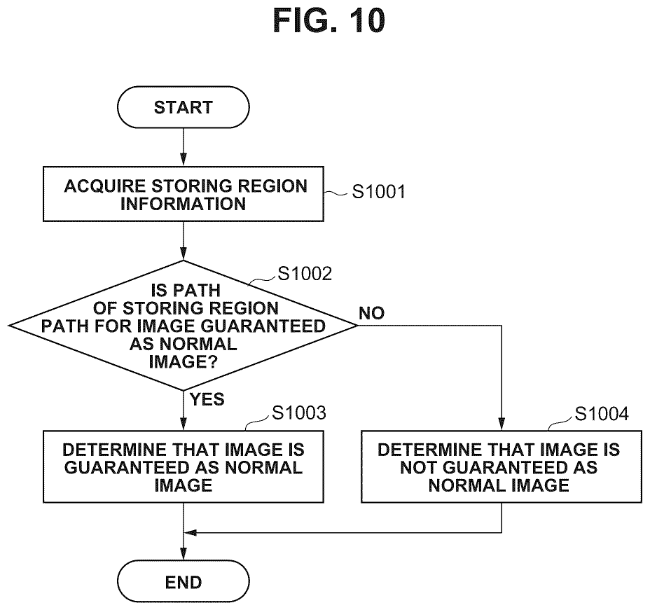

The flow of normality guarantee determination processing in the present exemplary embodiment is described with reference to FIG. 10 illustrating a flowchart of the processing.

In step S1001, the virus detection result determination unit 304 acquires storing region information regarding an image to be processed. The storing region information is information indicating a path of the storing unit 302 where the image is stored. The path where the image is to be stored is designated when the imaging apparatus 102, the user terminal 103, or the external server apparatus 104 transmits the image to the information processing apparatus 101, and the storing unit 302 stores the image on the designated path. At this time, in a case where the image is guaranteed as the normal image by the terminal/apparatus, the terminal or the apparatus transmits the image by designating a path for an image guaranteed as the normal image, and the image is stored on the path.

In step S1002, the virus detection result determination unit 304 determines whether the image is guaranteed as the normal image based on the storing region information. Specifically, in a case where the path of the storing region acquired in step S1001 is the path for the image guaranteed as the normal image (YES in step S1002), the processing proceeds to step S1003. In step S1003, the virus detection result determination unit 304 determines that the image is guaranteed as the normal image. In a case where the path is a path other than the path for the image guaranteed as the normal image (NO in step S1002), the processing proceeds to step S1004. In step S1004, the virus detection result determination unit 304 determines that the image is not guaranteed as the normal image.

According to the present exemplary embodiment described above, there is no need for adding normality guarantee information like in the first exemplary embodiment. Even in a case where the transmission source cannot be determined like in the second exemplary embodiment, it is possible to perform the normality guarantee determination processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible not to decrease convenience for a user who utilizes a file even in a case where execution of virus detection processing cannot be controlled.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-142033, filed Sep. 1, 2023, which is hereby incorporated by reference herein in its entirety.

What is claimed is:

1. An information processing apparatus comprising:
at least one processor and at least one memory, cooperating to:
receive a file;
store the received file;
perform virus detection processing on the file; and
determine whether the file is a normal file in a case where it is determined that the file is suspected of being infected with a virus or that the file is guaranteed as the normal file although an error occurs in the virus detection processing, as a result of the virus detection processing.

2. The information processing apparatus according to claim 1, wherein the file is guaranteed as the normal file based on normality guarantee information indicating whether the file is guaranteed as the normal file.

3. The information processing apparatus according to claim 2, wherein the normality guarantee information is included in a tag to be attached to the file.

4. The information processing apparatus according to claim 2, wherein the normality guarantee information is metadata information embedded in the file.

5. The information processing apparatus according to claim 1,
wherein the file is guaranteed as the normal file based on transmission source information.

6. The information processing apparatus according to claim 1, wherein the at least one processor and at the least one memory further cooperating to determine that the file stored in a specific storing region is the normal file.

7. The information processing apparatus according to claim 1, wherein the virus detection processing is performed on the file in a case where the file is stored in the at least one memory.

8. The information processing apparatus according to claim 1, wherein the virus detection processing is performed on the file using a function of an external service.

9. A processing method of an information processing apparatus, the processing method comprising:
receiving a file;
storing the received file;
performing virus detection processing on the file; and
determining whether the file is a normal file in a case where it is determined that the file is suspected of being infected with a virus or that the file is guaranteed as a normal file although an error occurs in the virus detection processing, as a result of the virus detection processing.

10. A non-transitory computer-readable storage medium storing a program causing an information processing apparatus to execute a processing method, the processing method comprising:
receiving a file;
storing the received file;
performing virus detection to perform virus detection processing on the file; and
determining whether the file is the normal file in a case where it is determined that the file is suspected of being infected with a virus or that the file is guaranteed as a normal file although an error occurs in the virus detection processing, as a result of the virus detection processing.
